(19) United States
(12) Patent Application Publication
(10) Pub. No.: US 2011/0003628 A1
(43) Pub. Date: Jan. 6, 2011

(54) SLOT MACHINE SYSTEM AND METHOD OF UTILIZING THE SAME

(76) Inventor: Joseph A. Marino, Birmingham, AL (US)

Correspondence Address: GREENBERG TRAURIG (LV), 3773 HOWARD HUGHES PARKWAY, Suite 400 North, LAS VEGAS, NV, 89169, US

(21) Appl. No.: 12/497,071

(22) Filed: Jul. 2, 2009

(51) Int. Cl. A63F 9/24; A63F 13/00

(52) U.S. Cl. 463/20; 463/30

(57) ABSTRACT

A system and method for facilitating a unique form of slot machine play whereby lottery and slot machine features are combined. Initially, random numbers in the form of lottery-style numbers (e.g., 3, 4, 5 or 6 numbers) are randomly selected from one or more pools of numbers. A plurality of slot machines include multiple reels depicting numbers corresponding to the pool of lottery numbers. Winning slot machine outcomes are based on a number of matches between numbers on the slot machine reels being aligned along a pay line and the previously drawn or generated lottery-style numbers. A bonus game icon in the form of a scratch-off ticket is also depicted on one or more slot machine reels. Responsive to said bonus icon aligning along a pay line, the player is able to play a simulated scratch-off ticket on a slot machine display incorporating touch screen technology.

### FIELD OF THE INVENTION

The embodiments of the present invention relate to electronic gaming devices and a method of playing the same. More particularly, the embodiments of the present invention relate to a slot machine and method of playing the same.

### BACKGROUND

Electronic gaming devices, such as slot machines, video poker machines and keno machines, now generate more revenue than table games. Specifically, the popularity of slot machines has increased with the number of game variations being offered. Bonus games, wild symbols, progressive jackpots and the like are now common features found on many slot machines.

Slot machines are the most popular of the electronic gaming machines. In general, slot machines comprise three or more mechanical or video reels depicting a plurality of gaming symbols. Payouts are based on the alignment of the gaming symbols along one or more active gaming machine pay lines. The basic slot machine concept is enhanced using the aforementioned features. However, to satisfy the gaming public, electronic gaming machine manufacturers are constantly seeking new features to enhance electronic gaming machines.

Thus, there continues to be a need for new slot machines and methods of playing them.

### SUMMARY

Accordingly, a first slot machine embodiment of the present invention is a slot machine comprising: a processor operable to control said slot machine; a random number generator operable to generate random slot machine outcomes; three to six game reels; each game reel depicting at least a plurality of reel numbers; and wherein said processor causes said slot machine to signal a winning outcome in response to one or more of said reel numbers aligning along a pay line and matching one or more of a series of previously, randomly generated lottery-style numbers.

A first slot machine system comprises: a plurality of slot machines in communication with a central computer, each of said slot machines comprising: a processor operable to control said slot machine; a random number generator operable to generate random slot machine outcomes; three to six game reels; a lottery number generating means; and wherein said processor causes said slot machine to signal a winning outcome in response to one or more of said reel numbers aligning along a pay line and matching one or more of a series of previously, randomly generated lottery-style numbers.

A first method embodiment of the present invention comprises: randomly selecting a series of lottery-style numbers; communicating the series of lottery-style numbers to a plurality of slot machines forming a network, said slot machines having three to six reels wherein each of said reels depict a plurality of reel numbers which collectively include a pool of numbers from which said lottery-style numbers are drawn; and causing said plurality of slot machines to signal a winning outcome responsive to slot machine outcomes matching one or more of said lottery-style numbers.

In general, the embodiments of the present invention are based on matching game reel symbols with previously selected lottery style numbers or symbols. Payouts may relate to matching one or more lottery style numbers or symbols.

Other variations, embodiments and features of the present invention will become evident from the following detailed description, drawings and claims.

### BRIEF DESCRIPTION OF THE DRAWINGS

FIG. 1 shows a conventional video slot machine;

FIG. 2 shows a configuration of reels a first mechanical embodiment of the present invention;

FIG. 3 shows a configuration of reels a first video embodiment of the present invention;

FIG. 4 shows a block diagram of a system embodiment of the present invention;

FIG. 5 shows a flow chart detailing one method embodiment of the present invention; and

FIG. 6 shows listing of possible game schemes utilizing embodiments of the present invention.

### DETAILED DESCRIPTION

The operation of slot machines is controlled by microprocessors which communicate with internal memory devices and the external features of the machines. The microprocessors also incorporate, or communicate with, a random number generator which ensures the randomness of the machines' outcomes. In the embodiments of the present invention, one or more processors, along with memory and related devices, control the new applications disclosed herein. Therefore, the embodiments, along with the corresponding odds, of the present invention may be programmed into the processor or associated software. Since the technology for operating and controlling slot machines is well known to those skilled in the art, the subtle details are not described herein.

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention seek to combine lottery features and slot machine features into a single system and methodology. In general, potential winning lottery numbers are first randomly drawn or generated. A plurality of slot machines having reels depicting numbers corresponding to the lottery numbers are then provided with the winning lottery numbers. Thereafter, players play the slot machines in an effort to obtain a slot machine outcome with numbers aligned along a pay line duplicating the previously drawn or generated lottery numbers. A series of prizes and awards responsive to pre-established slot machine outcomes is created to attract players. In one embodiment, a large progressive jackpot is associated with a slot machine outcome matching each lottery number. Smaller prizes relate to less than all numbers matching. The term “lottery” is used herein to reference any set of randomly drawn or generated numbers. In fact, state lottery numbers can be the basis for an intrastate or interstate embodiments of the present invention.

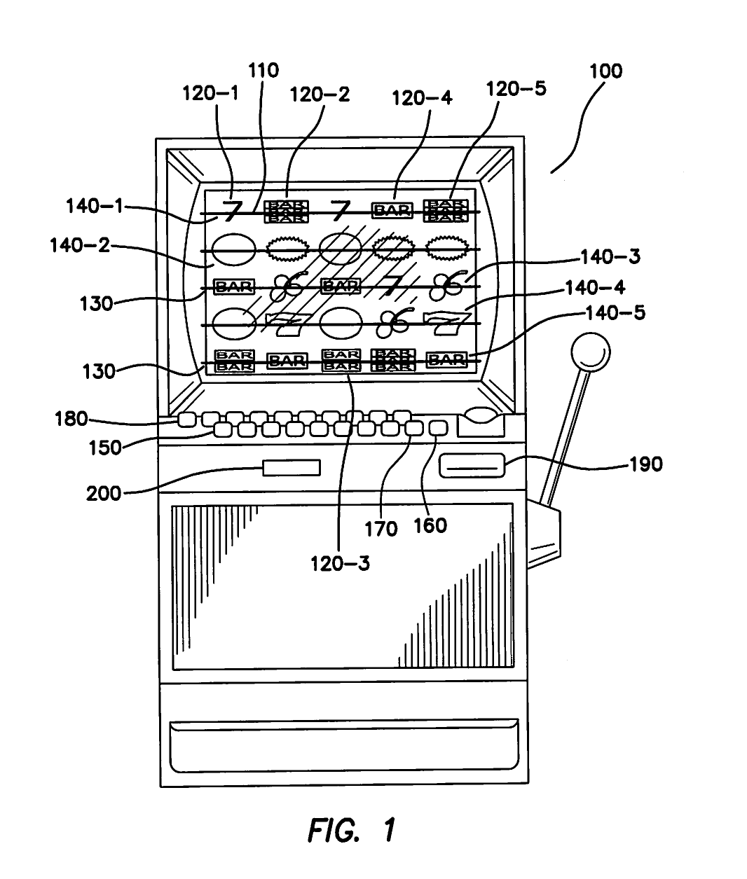

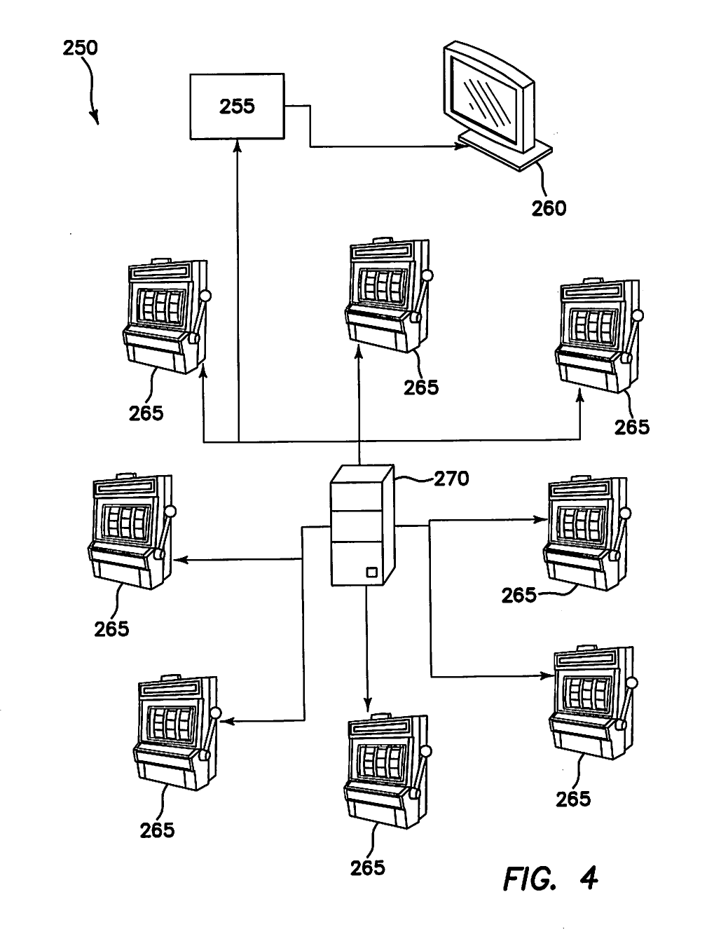

Reference is now made to the figures wherein like parts are referred to by like numerals throughout. FIG. 1 shows a conventional video slot machine, with conventional gaming indicia, generally referred to by reference numeral 100. A video screen 110 displays five primary vertical game reels 120-1 through 120-5 comprising a plurality of gaming indicia 130. With the embodiments of the present invention, the gaming indicia comprise at least numbers in the form of integers. FIG. 1 shows five horizontal pay lines 140-1 through 140-5. In practice, video slot machines can incorporate many more pay lines (e.g., 20). Upon activation, the video reels 120-1 through 120-5 spin and stop according to pre-established positions randomly determined by the machine's random number generator or similar device. Wagers are resolved based on the gaming indicia which align along active pay lines. In certain embodiments, players are able to select the number of active pay lines prior to play. Generally, the more pay lines selected, the greater the number of coins or units which must be wagered. Player interface buttons include a one wager button 150, maximum wager button 160, spin button 170 and cash out button 180. The slot machine 100 also integrates a card reader 190, ticket reader and bill validator 200. 100201 The embodiments of the present invention comprise a correspondence between a set of lottery style numbers and the gaming indicia 130 on the reels of a network of slot machines. FIG. 4 shows a system 250 comprising a lottery number generating or drawing means 255 and display 260, plurality of slot machines 265 and central computer 270 (e.g., server). The plurality of slot machines 265 may be located in a single casino, across commonly owned casinos or in any number of independently owned casinos. The lottery number generating or drawing means 255 may be an electronic random number generator, ball blower, ticket bin or any other device capable of facilitating the generation of random numbers. In one embodiment, six lottery numbers are drawn or generated from six groups of numbers with each group comprising numbers ranging from one to sixty. Alternatively, akin to a state lottery, the six lottery numbers are selected from a single pool of numbers ranging from one to sixty.

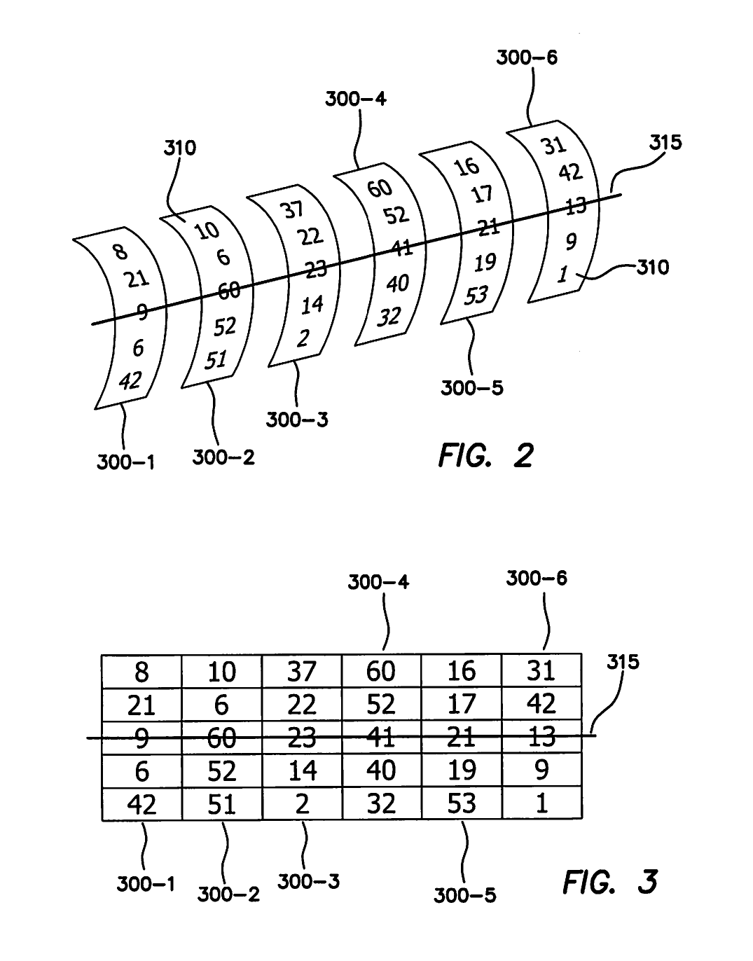

FIGS. 2 and 3 show a configuration of six mechanical and video reels 300-1 through 300-6. In one embodiment, as shown, each of the six reels 300-1 through 300-6 depicts sixty numbers ranging from one to sixty 310. Each of the reel numbers 310 also comes with an associated color. In one embodiment, there are six colors such that each reel 300-1 through 300-6 depicts six groups of ten numbers having a same color. The colors may be randomly assigned or purposefully assigned to the reel numbers 310. The sixty numbers 310 on each reel 300-1 through 300-6 correspond to the pool of lottery numbers (e.g., integers 1-60). The numbers 310 may be consecutively depicted on the reels 300-1 through 300-6 or may be randomly arranged. In one embodiment, the machine's random number generator utilizes reel positions to determine where each of the reels 300-1 through 300-6 will stop after activation. It will be understood by those skilled in the art that more or less than sixty numbers 310 may be depicted on each reel 300-1 through 300-6 and the machines may include more or less than six reels 300-1 through 300-6. Pay line 315 determines winning outcomes. More than one pay line may be used.

In another embodiment, each reel includes a plurality of lottery numbers forming a sub-set of the pool of lottery numbers. For example, the pool of lottery numbers may be integers 1-60 and each of the six reels 300-1 through 300-6 includes a sub-set comprising integers 1-10, 11-20, 21-30, 31-40, 41-50 and 51-60. In this embodiment, the lottery numbers are also grouped into sub-sets such that one lottery number is selected from each group comprising integers 1-10, 11-20, 21-30, 31-40, 41-50 and 51-60 so that it is always possible for the reel outcomes to match the selected lottery numbers.

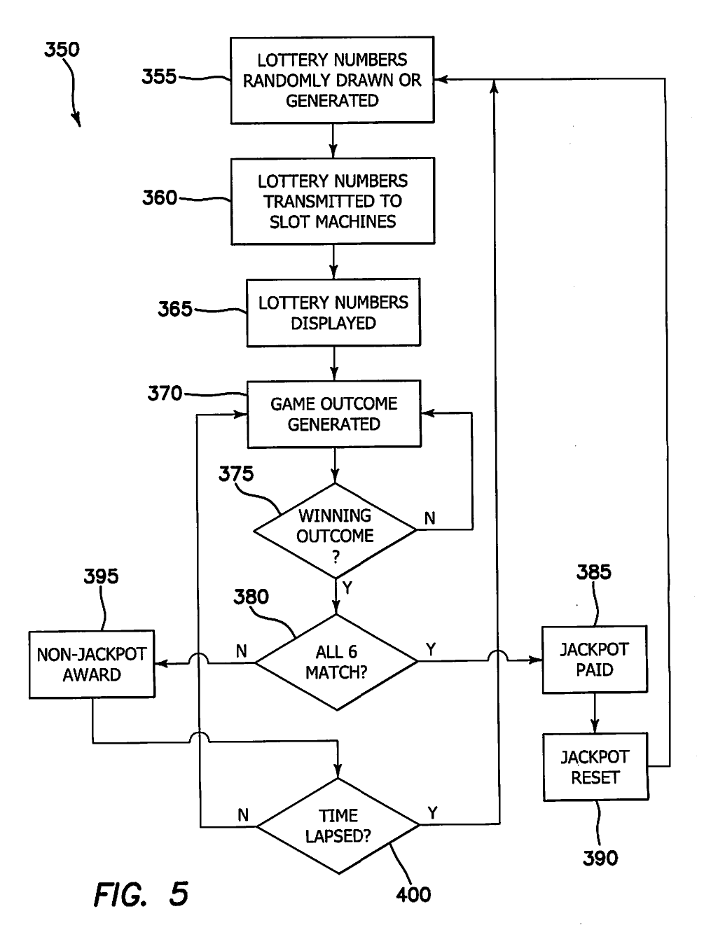

FIG. 5 shows a flow chart 350 detailing one method embodiment of the present invention. At 355, lottery numbers are randomly drawn or generated. As set forth above, the numbers may correspond to state lotteries or may be exclusive to the applications discussed herein. At 360, the randomly drawn or generated lottery numbers are transmitted to participating slot machines 265. In one embodiment, the lottery numbers are transmitted via a wired connection or wirelessly to the central computer 270 which then transmits the winning numbers to the slot machines 265 where they are stored. Alternatively, the slot machines 265 may poll the central computer after each activation of the slot machines 265 to compare slot machine outcomes to the stored lottery numbers. At 365, the lottery numbers are displayed in some fashion for the slot machine players to observe. The lottery numbers may be displayed on the slot machines 265, slot machine bank displays, large casino displays or elsewhere. At 370, a slot machine outcome is generated. At 375, each outcome of the slot machines 265 is compared to the lottery numbers to determine whether there is a winning match. If so, at 380, it is determined whether all six numbers match. Max coins may be required to award the progressive or fixed jackpot. If so, at 385, a jackpot is paid and, at 390, the game is reset with the selection of new lottery numbers at 355, and if the jackpot is progressive, it is reset to a minimum starting value. If no jackpot is won, the jackpot, if progressive, may be increased as known in the art. If less than six slot machine numbers match the lottery numbers, but enough for a winning outcome, at 395, a non-jackpot payout is awarded. In one embodiment, as set forth below, with six lottery numbers and six reels, three to six matching numbers are deemed a winning outcome with three, four and five matching numbers resulting in various increasing payouts. Certain color combinations and other number combinations may also be deemed winners. If no winning outcome occurs, the chart 350 loops back to 375. At 400, it is determined whether a pre-established time period (e.g., one week) has expired. If not, the chart loops back to 375. If so, the chart loops back to 355 so that new lottery numbers can be randomly drawn or generated. It is not necessary for the lottery numbers to be re-drawn until after the jackpot is won, but setting a time period is one methodology to maintain interest in the game.

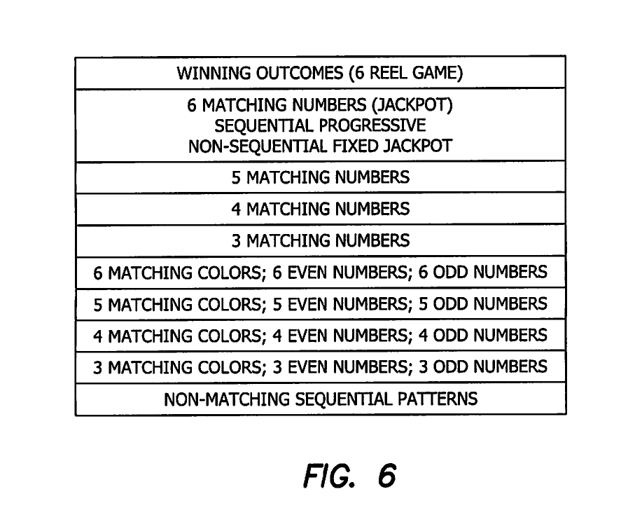

Various winning outcomes can be created with the embodiments of the present invention. Accordingly, the following description of certain winning outcomes should be considered exemplary only. The primary objective of the game is to match numbers on the reels with the previously drawn lottery numbers non-sequentially or sequentially. For example, the lottery numbers may be 3, 13, 10, 45, 60 and 23 such that the slot machine player is seeking to match each of the lottery numbers on the six reels 300-1 through 300-6. A sequential match (i.e., number 3 from reel 1 aligning along the pay line; number 13 from reel 2 aligning along the pay line; number 10 from reel 3 aligning along the pay line; number 45 from reel 4 aligning along the pay line; number 60 from reel 5 aligning along the pay line; and number 23 from reel 6 aligning along the pay line) of all 6 numbers may correspond to the progressive jackpot while a non-sequential match of all 6 numbers may correspond to a lesser jackpot. Besides matching reel numbers with lottery numbers, and assuming six reels, payouts may include 3 to 6 numbers having matching colors, 3 to 6 even numbers, 3 to 6 odd numbers, sequential patterns (these winning outcomes are based on the numbers on the reels 300-1 through 300-6 only and have no correspondence with the lottery numbers) and any other conceivable scheme that can be developed using a series of reel numbers 310. Moreover, besides the weekly lottery drawing or generation of the six lottery numbers described herein, smaller bi-weekly (e.g., five random selections ranging from 1-30) or nightly (e.g., three random selections ranging from 1-15) may be implemented with corresponding smaller prizes. FIG. 6 shows some exemplary payout schemes that may be used with the embodiments of the present invention.

In one embodiment, when winning outcomes occur, the winning numbers 310 are highlighted on the mechanical or video reels so that the player is immediately aware of the winning outcome. Any time a reel number 310 matches a lottery number the reel number 310 may highlight (e.g., illuminate) so that more anticipation and excitement is created. For example, if the first two reel numbers match the lottery numbers the player is very excited that one or more of the remaining four reels will match as well.

In one embodiment, a bonus scratch-off icon is depicted on each reel 300-1 through 300-6. Responsive to a scratch-off icon aligning along a pay line, the player is provided the opportunity to play a simulated scratch-off ticket on a slot machine display incorporating touch screen technology. The simulated scratch-off ticket, like physical scratch-off tickets, may result in a money or products prize. In one embodiment, payouts range from $1 to $50,000 relative to the simulated scratch-off tickets.

Although the invention has been described in detail with reference to several embodiments, additional variations and modifications exist within the scope and spirit of the invention as described and defined in the following claims.

I claim:

1. A slot machine comprising:
a processor operable to control said slot machine;
a random number generator operable to generate random slot machine outcomes;
three to six game reels;
each game reel depicting at least a plurality of reel numbers; and
wherein said processor causes said slot machine to signal a winning outcome in response to one or more of said reel numbers aligning along a pay line and matching one or more of a series of previously, randomly generated lottery-style numbers.

2. The slot machine of claim 1 wherein the slot machine is configured to receive updated lottery-style numbers from a central computer.

3. The slot machine of claim 1 further comprising six reels with each reel depicting sixty reel numbers ranging from one to sixty.

4. The slot machine of claim 1 wherein each reel further depicts a scratch-off bonus icon operable to trigger a bonus game in the form of a simulated scratch-off ticket.

5. The slot machine of claim 1 wherein said lottery numbers are displayed on a slot machine display.

6. The slot machine of claim 1 wherein said processor causes reel numbers which match said lottery-style numbers to illuminate.

7. The slot machine of claim 1 wherein each reel comprises a unique plurality of reel numbers.

8. A slot machine system comprising:
a plurality of slot machines in communication with a central computer, each of said slot machines comprising:
a processor operable to control said slot machine;
a random number generator operable to generate random slot machine outcomes;
three to six game reels;
a lottery number generating means; and
wherein said processor causes said slot machine to signal a winning outcome in response to one or more of said reel numbers aligning along a pay line and matching one or more of a series of previously, randomly generated lottery-style numbers.

9. The slot machine system of claim 8 wherein said plurality of slot machines are configured to receive updated lottery-style numbers.

10. The slot machine system of claim 9 wherein said plurality of slot machines are configured to receive the updated lottery-style numbers from said central computer which is configured to receive the lottery-style numbers from the lottery number generating means.

11. The slot machine system of claim 8 wherein said plurality of slot machines comprise six game reels with each game reel depicting sixty reel numbers ranging from one to sixty.

12. The slot machine system of claim 8 wherein each reel further depicts a scratch-offbonus icon operable to trigger a bonus game in the form of a simulated scratch-off ticket.

13. The slot machine system of claim 8 further comprising at least one display configured to display said lottery-style numbers.

14. The slot machine system of claim 8 wherein said processor causes reel numbers which match said lottery-style numbers to illuminate.

15. The slot machine system of claim 8 wherein each reel comprises a unique plurality of reel numbers.

16. A gaming method comprising:
randomly selecting a series of lottery-style numbers;
communicating the series of lottery-style numbers to a plurality of slot machines forming a network, said slot machines having three to six reels wherein each of said reels depict a plurality of reel numbers which collectively include a pool of numbers from which said lottery-style numbers are drawn; and
causing said plurality of slot machines to signal a winning outcome responsive to slot machine outcomes matching one or more of said lottery-style numbers.

17. The method of claim 16 further comprising configuring said plurality of slot machines to receive updated lottery-style numbers.

18. The method of claim 17 further comprising configuring said plurality of slot machines to receive the updated lottery numbers from a central computer forming part of the network

19. The method of claim 18 further comprising transmitting updated lottery-style numbers to the central computer from a lottery number generating means forming part of the network.

20. The method of claim 16 wherein each of said plurality of slot machines comprises six game reels with each game reel depicting sixty reel numbers ranging from one to sixty.

21. The method of claim 16 further comprising triggering a scratch-off bonus game responsive to a scratch-off bonus icon aligning along a slot machine pay line.

22. The method of claim 16 further comprising causing reel numbers which match said lottery numbers to illuminate on said slot machines.

23. The method of claim 16 wherein each of said plurality of slot machines comprises multiple reels wherein each multiple reel depicts a unique set of reel numbers.
